(19) United States
(12) Patent Application Publication
(10) Pub. No.: US 2020/0320583 A1
(43) Pub. Date: Oct. 8, 2020

(54) NOTIFICATION-BASED PUBLICATION OF SECONDARY CONTENT ON AN ELECTRONIC PRIMARY NETWORK

(71) Applicant: Sylkar LLC, Glendale, CA (US)

(72) Inventor: Vahe Nick Karapetian, Los Angeles, CA (US)

(21) Appl. No.: 16/840,420

(22) Filed: Apr. 5, 2020

Related U.S. Application Data
(60) Provisional application No. 62/830,001, filed on Apr. 5, 2019.
(60) Provisional application No. 62/898,399, filed on Sep. 10, 2019.

(51) Int. Cl. G06Q 30/02; G06Q 50/00

(52) U.S. Cl. CPC G06Q 30/0277; G06Q 50/01

(57) ABSTRACT

Systems and methods for improved delivery of secondary content, such as advertisements or news articles, and the like, in an electronic primary content network, such as a media streaming or social network, are disclosed. Such systems and methods may include automated determination of recommended viewing users for the secondary content and provision of compensation to targeted viewing users who perform a desired action with respect to an item of secondary content, such as viewing the content, answering questions related to the content, following a link associated with the content, etc.

### CROSS-REFERENCE TO RELATED APPLICATIONS

This application claims priority to U.S. provisional application No. 62/830,001, filed on Apr. 5, 2019, and U.S. application No. 62/898,399, filed on Sep. 10, 2019, both of which applications are hereby incorporated by reference in their entireties.

### TECHNICAL FIELD

This disclosure generally relates to selection of viewing users for secondary content, such as advertisements, obtaining consent from potential viewing users to view the content, and presentation of that content to the viewing users in a streaming, social, or other electronic primary content network.

### BACKGROUND

Third-party secondary content providers, such as advertisers, have long recognized primary content networks such as streaming networks and social networks as desirable outlets for secondary content. Third-party content may be published to streaming and social networks according to a traditional model in which the third-party content provider compensates the network owner in exchange for publishing the content on the network, or when a publishing user of a social network discovers the third-party content and publishes it, or when the third-party content provider discovers a user independently and asks that user to publish the content. Alternatively, publication may be based on an algorithm of the network itself, i.e., automated publication to specific viewing users selected by the network provider, or publication to a public feed of the network.

### BRIEF DESCRIPTION OF THE DRAWINGS

FIG. 1 is a diagrammatic view of an example embodiment of an electronic system for selecting target viewing users for third-party content on an electronic network and presenting the content to the targeted viewing users.

FIG. 2 is a diagram illustrating an example of publication of third-party content in public and private feeds in a social network and use and security of user engagement data respective of such content.

FIG. 3 is a flow chart illustrating an example method for presenting third-party content to one or more users of an electronic network.

FIG. 4 is a flow chart illustrating an example method of selecting users to recommend as target viewers for third-party content and recommending social media feeds publication of third-party content.

FIG. 5 is a flow chart illustrating an example method of selecting users as target viewers for third-party content.

FIG. 6 is a flow chart illustrating an example method of presenting third-party content, such as an advertisement, to one or more users of a social media network, content streaming network, or other electronic network.

FIG. 7 is a diagrammatic view of an example embodiment of a user computing environment.

### DETAILED DESCRIPTION

Known methods and systems for presenting third-party secondary content or third-party-directed content in streaming networks, social media networks, and other electronic primary content networks can be improved upon in several ways. First, known methods and systems may not provide publishing users adequate (or any) control over which secondary third-party content or third-party-directed content appears alongside the publishing user's own primary content, and/or may not provide the third-party content provider adequate (or any) input into where and when the secondary content is published. Second, known methods and systems may not provide third-party secondary content providers sufficient insight into which viewing users are appropriate or preferable target viewers or which publishing users control appropriate primary content channels for reaching those target viewing users, or allow third-party secondary content providers to select from such target viewing users or publishing users. Third, known methods and systems may not adequately utilize data respective of viewing user activity in primary content networks for determining user interests (which can be used to determine which users are preferable target viewers of content) while also protecting the users' privacy in that data. Fourth, known methods and systems may not provide viewing users sufficient incentive to view secondary content, or provide publishing users sufficient ability to incentivize such viewing.

Publication of third-party secondary content or third-party-directed secondary content in an electronic primary content network according to the present disclosure may improve upon known systems and methods. Publication of third-party content or third-party-directed content according to the present disclosure may include, in embodiments, automatically determining appropriate or preferred viewing users to be target viewers of third party content based on viewing user characteristics and based on target viewing user parameters provided by the content provider. Publication of third-party content or third-party-directed content according to the present disclosure may also include, in embodiments, allowing third-party content providers to select from recommended target viewing users, or publishing user feeds to which such target viewing users subscribe, for its content. Publication of third-party content or third-party-directed content according to the present disclosure may also include, in embodiments, allowing publishing users to select from third party content to be run in conjunction with the publishing user's own content, with knowledge of the third-party content or third-party-directed content and compensation associated with publication of the third party content alongside the publishing user's own content. Publication of third-party content or third-party-directed content according to the present disclosure may also include, in embodiments, extrapolating viewing user interests from viewing user interactions and activity in the electronic network, while also protecting the viewing user's privacy in the underlying data.

Publication of third party secondary content to viewing users according to the present disclosure may further include selecting one or more viewing users to receive an item of secondary content, such as an advertisement, news, etc., and transmitting a notification to each of the users. The notification may include an indication of the item of secondary content that is intended for the viewing user and an indication of compensation that will be provided to the viewing user if the viewing user views the secondary content or other action respective of the secondary content. The viewing user may provide a response to the notification. If the viewing user responds affirmatively, the item of secondary content may be transmitted to the viewing user, and the viewing user may be compensated for receiving and viewing the secondary content. Notification-based and acceptance-based publication of content according to the present disclosure may find use on a social network, media streaming network, or other internet-based primary content delivery network. Primary content may include, for example, television shows, movies, social media posts created by a social media end user, and other content that fits the underlying purpose of the electronic content network.

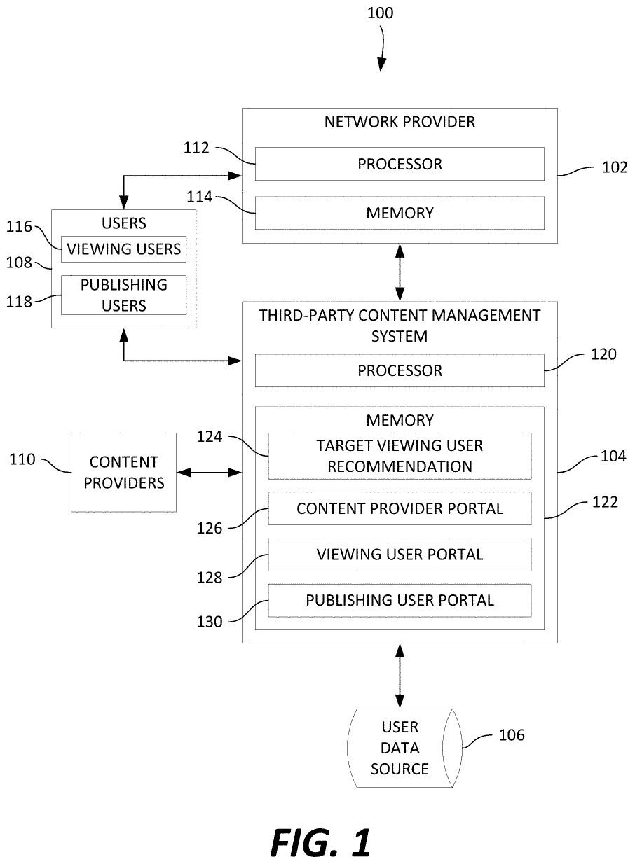

Referring to the drawings, wherein like reference numerals refer to the same or similar features in the various views, FIG. 1 is a diagrammatic view of an example embodiment of an electronic system 100 for selecting viewing users as target viewers for third-party secondary content or third-party-directed secondary content, such as news, advertisements, etc., and presenting such content to viewing users on an electronic primary content network, such as a media streaming network, social network, etc. The system 10 may include a primary content network provider 102, a third party content management system 104, a viewing user data source 106, one or more users 108, and one or more third-party secondary content providers 110.

The network provider 102 may include a processor 112 and a non-transitory, computer-readable memory 114 configured to store data and instructions. The processor 112 may be configured to execute instructions stored in the memory 114 to perform one or more of the steps, methods, algorithms, etc. of this disclosure.

The network provider 102 may be configured to host and serve a content provision network, such as a media streaming platform, a social networking platform, or another form of electronic content delivery, to and for one or more publishing and users 108. The network provider 102 may thus comprise one or more servers, databases, and/or other computing devices necessary or useful for electronically hosting and serving a content hosting and networking platform. The network provider 102 may provide the primary content delivery network through one or more websites, applications, and/or other electronic interfaces.

In some embodiments, the network provider 102 may be configured to provide a media streaming network that provides video, audio, or other media streamed to a user computing device. The media streaming network may provide primary content such as songs, movies, television shows, short videos, and other entertainment content, in some embodiments. The media streaming network may also provide secondary content such as advertisements, in some embodiments.

The users 108 may include one or more viewing users 116 and, in some embodiments, one or more publishing users 118. Viewing users 116 may be users of an electronic network that view content through that network. Publishing users 118 may be users of an electronic network that publish content to the network. In some embodiments, a single user may be both a viewing user 116 and a publishing user 118. For example, on a social network, a single user may be both a publishing user 118 by posting their own videos, text, pictures, etc., and may be a viewing user 116 by viewing the videos, text, pictures, etc. posted by other publishing users 118.

In some embodiments, the network provider 102 may be configured to provide a social network in which a user can define one or more feeds (which may be referred to herein as “bubbles”), in an embodiment. A “bubble” may consist of a publishing user 118 of the social network that owns the bubble and one or more viewing users 116 which are able to view the content posted to the bubble by the publishing user 118. Viewing users 116 may be subscribed to the bubble, in some embodiments. The publishing user 118 may post content to the bubble, which content may be viewed by viewing users 116 such as subscribers to that bubble, in an embodiment. Viewing users 116 may interact with content posted by the publishing user 118 (e.g., by commenting, liking, etc.), but may not otherwise post content to the bubble, in an embodiment. A given publishing user 118 may own one or more bubbles, and viewing users 116 may subscribe to or otherwise access and view one or more bubbles, in embodiments.

The network provider 102 may accept primary and secondary content and other input from users 108 and publish that content and other input to the network to achieve the functionality of the network described herein. The network provider 102 may accept and publish content in the form of text, images, videos, and other digital media. In embodiments in which the network provider 102 provides a streaming network, the network provider 102 may publish content in general public feeds and/or in user-specific feeds, including public feeds tailored to one or more viewing users 116 and private feeds specific to particular viewing users 116. In embodiments in which the network provider 102 provides a social network, the network provider 102 may also publish content to a public feed, in an embodiment, that is accessible to all or substantially all viewing users 116, in addition to or instead of publishing to a bubble. Still further, in social network and media streaming network embodiments and other embodiments, the network provider 102 may also provide direct messaging and/or other communication functionality to enable users 108 to communicate with each other and/or with third party content providers 110.

A social network hosted by the social network provider 102 may include both private and public bubbles, in an embodiment. When a publishing user 118 publishes content to a public bubble, that content may be visible to viewing users 116 of the social network, including subscribers to that public bubble and other viewing users 118. Further, viewing user 116 interactions with posted content (e.g., comments, likes, etc.) may be visible to the publishing user 118 who owns the bubble, to bubble subscribers, and to other users of the social network.

For private bubbles in the social network, when the publishing user 118 posts content, that content may be visible only to viewing users 116 who are subscribers of that bubble, but not to other viewing users 116 (i.e., viewing users 116 who are not subscribed to that private bubble) of the social network. Further, viewing user 116 interaction with that content (e.g., likes, comments, etc.) may be visible to the publishing user 118 who owns the private bubble and to subscribers to the bubble, but not to non-subscriber viewing users 116 of the social network.

The social network provider 102 may be in electronic communication with the third-party content management system 104 for the third-party content management system to provide third-party content to be published on the social network. Accordingly, the social network provider 102 may accept content from the third-party content management system 104 for publication on the social network, the social network provider 102 may provide an API through which the third-party content management system 104 may publish content to the social network, and/or the social network provider 102 may otherwise enable content from the third-party content management system 104 to be published on the social network. Additionally or alternatively, one or more aspects of the third-party content management system 104 described herein may be a part of or implemented by the social network provider 102.

The users 108 may access the network provided by the network provider 102 via computing devices, such as personal computers, smartphones, and tablets. The users 108 may thus be in electronic communication with the network provider 102 via the internet, a local or wide area network, a cellular network, and/or through other networking channels. The network provider 102 may host and serve the network such that users 108 may view the network on the displays of the users' 108 electronic devices.

Accordingly, the network provider 102 may host and serve a website comprising one or more web pages, may host information to be displayed in an application on user devices, may host information to be accessed through a thin client on user devices, and/or may otherwise host the network for access by the users 108.

The users 108 may also be in electronic communication with the third-party content management system 104 to review third-party content and accept third-party content to appear in feeds on the network provided by the network provider 102. The users 108 may also receive, from the third-party content management system 104, notifications of third-party content and respond with acceptance or denial of such third-party content, in some embodiments.

The third-party content providers 110 may be one or more entities that are interested in having their content displayed to users on the network provided by the network provider 102. Content provided by the third-party content providers 110 may include, for example, news articles and videos, entertainment media, advertisements, etc. The third-party content providers 110 may be in electronic communication with the third-party content management system 104 with one or more third-party content provider computing systems. The third-party content providers 110 may be in electronic communication with the third-party content management system 104 via the internet, a local or wide area network, a cellular network, and/or through other networking channels.

The user data source 106 may include one or more databases or other non-transitory, computer-readable memory for the storage of data respective of the users 108 of the network provided by the network provider 102. The user data source 106 may store profiles respective of the users 108, in an embodiment, including profiles respective of the viewing users 116. Such profiles may include, or may be associated with, data collected from user activity on the network, data provided directly by the users 108, and/or data from other sources, in an embodiment. For example, in an embodiment, the user data source 106 may include user data from retailers, websites, search engines, and/or other entities that collect user data. Although the user data source 106 is illustrated as a separate entity from the third-party content management system 104, the user data source 106, or portions thereof, may be a part of the third-party content management system 104, in embodiments.

The user data source 106 may additionally include information regarding publishing user 118 ownership of, and viewing user 116 subscriptions to, one or more feeds on a social network provided by the network provider 102 (in embodiments in which the network provider 102 provides such a social network). Accordingly, the user data source 106 may include records of which publishing users 118 of the social network own which bubbles, and which viewing users 116 are subscribers to each bubble, for public bubbles and/or private bubbles.

The user data source 106 may have information respective of each bubble on a social network provided by the network provider 102, in an embodiment. The data in the user data source 106 may be anonymous, in an embodiment, and such data may be related to specific users 108 by the network provider 102, for example. The social network may relate the stored data to specific users through an encoded lookup table, for example.

The third-party content management system 104 may include a processor 120 and a non-transitory, computer-readable memory 122 configured to store data and instructions. The processor 120 may be configured to execute instructions stored in the memory 122 to perform one or more of the steps, methods, algorithms, etc. of this disclosure. In particular, the memory 122 may store various functional modules in the form of instructions, including a target viewing user recommendation module 124, a content provider portal module 126, a publishing user portal module 128, and a viewing user portal module 130.

The various modules 124, 126, 128, 130 in the memory 122 will be described separately, but it should be understood that such separation is for ease of discussion only. The instructions in which the various modules 124, 126, 128, 130 are embodied may be in common files, storage devices, etc. and, similarly, one or more of the modules 124, 126, 128, 130 described herein may be separated into multiple separate files, storage devices, etc.

The third-party content management system 104 may manage third-party content for one or more networks, and thus for one or more network providers 102, in embodiments. Accordingly, the third-party content management system 104 may be in electronic communication with one or more network providers 102. In an embodiment in which the third-party content management system 104 manages content for numerous network providers 102, each of those network providers 102 may be associated with its own set of users 108 and/or its own user data source 106, in embodiments.

The target viewing user recommendation module 124 may receive content from a third-party content provider 110 and/or target viewing user parameters from a third-party content provider 110, may access the user data source 106, and may determine appropriate, preferred, or recommended viewing users 116 for the content, and/or appropriate, preferred, or recommended feeds in which to publish the content. The target viewing user recommendation module 124 may determine recommended viewing users 116 for advertisements, as discussed in further detail below. The recommendations from the target viewing user recommendation module 124 may be output by the third-party content management system 104 for the relevant third-party content provider 110, in embodiments, as will be discussed in greater detail herein.

The third-party content provider portal module 126 may include functionality through which a third-party content provider 110 communicates with the third-party content management system 104 to submit content, receive recommended target viewing users 116 and target user feeds for that content, select target viewing users 116 and target user feeds (e.g., bubbles) for that content, communicate with publishing user 118 owners of target user feeds, and cause the content to be published to selected target feeds. Accordingly, the third-party content provider portal module 126 may accept content (e.g., as text, images, videos, etc.), target viewing user parameters associated with of that content (e.g., interests, demographic characteristics, etc.), and/or conditions of publication of the content (e.g., compensation to publishing users 118 of feeds in which the content is published). The third-party content provider portal module 126 may further list viewing users 116 and/or feeds that are recommended by the third-party content management system 104 as target viewing users 116 or target feeds for content for review by the third-party content provider 110. The third-party content provider portal module 126 may further receive feedback from the third-party content provider 110 to select one or more recommended targets for the content.

The publishing user portal module 128 may include functionality through which a publishing user 118 communicates with the third-party content management system 14 to review proposed content from third-party content providers 110, to accept content for publication in user-owned feeds, and/or to schedule publication of that content. Accordingly, the publishing user portal module 128 may display proposed content for the publishing user 118, along with information about the content (e.g., compensation associated with publication of the content), receive feedback from feed owner users about which content is accepted and which content is rejected, and accept input from a feed owner user about when to publish accepted third-party content in the user owned feed(s), among other functionality.

The viewing user portal module 130 may include functionality through which a viewing user 116 communicates with one or more third-party content providers 110 to review proposed content from third-party content providers 110, to accept content for publication in user-viewed feeds, and to communicate with the content provider 110 regarding compensation for viewing the content of the content provider 110.

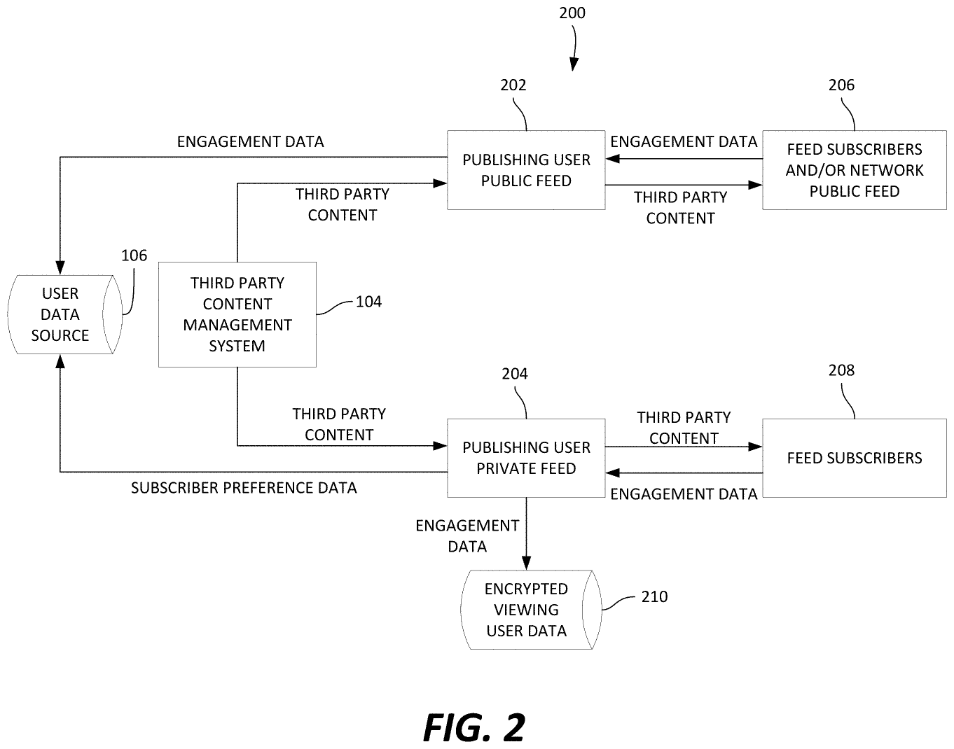

FIG. 2 is a diagram 200 illustrating example data flow and storage for content posted in private and public feeds on a social network. As noted above, known systems and methods for publication of third-party content on a social network may not utilize user data to determine user characteristics, and thus be able to better select appropriate users to receive advertisements and other content, while also protecting user privacy in that data. The diagram 200 of FIG. 2 illustrates an example improved approach.

As shown in FIG. 2, the third-party content management system 104 may publish third party content to both user public feeds 202 and to user private feeds 204. In an embodiment, such a public feed 202 and/or private feed 204 may be a “bubble” as described herein. For third-party content published to a public feed 202, the content may be published to and viewed by (represented by block 206) subscribers to the feed and/or by other users of the social network (that is, viewing users) (e.g., through a public feed of the network). In turn, the viewing users may engage with that content (e.g., by commenting, “liking”, etc.) in the user public feed 202, which engagement may be captured as engagement data respective of the user public feed. That follower engagement data may be stored in the user data source 106, in embodiments, such that the user data source 106 has a record of the viewing user engagement with the third-party content in the public feed, which user engagement data may be used to supplement the respective profiles of the respective viewing users that have engaged with the content.

In contrast, for third-party content published to a private feed 204, the content may be published to and viewed by subscribers to the feed only, not by other users of the social network (as represented by block 208). In turn, the viewing users may engage with that content (e.g., by commenting, “liking”, etc.) in the user private feed, which engagement may be represented by engagement data respective of the user private feed. The third-party content management system 104 may determine preferences of the viewing users based on the engagement data respective of the user private feed, and may store that preference data in the user data source, which preference data may be used to supplement the respective profiles of the respective viewing users that have engaged with the content. The engagement data respective of the private feed itself, however, may be encrypted and stored in an encrypted user data store 210. The encrypted user data store 210 may be decryptable only with a decryption key given to the user that owns the feed from which the user engagement data was collected, in an embodiment, and thus the user engagement data may be inaccessible to the third-party content management system itself 104. This, also, is in contrast to content in a public user feed 202, the user engagement data of which may be stored directly in the user data store 106 in a manner accessible to the third-party content management system.

Although the encrypted user data 210 is illustrated as a separate entity from the third party content management system 104 and the user data source 106 in FIG. 2, it should be understood that the encrypted user data 210 may be stored in the user data source 106 (e.g., as a separately-encrypted portion) and/or in the memory of the third-party content management system 104, in embodiments.

The data collection, storage, and encryption operations of this disclosure advantageously protect user privacy in data respective of user engagement with content in private feeds, while also extrapolating from that data to provide an improved understanding of the user's interests, and accounting for public data respective of the user for the same purpose. Furthermore, by providing access to data respective of user engagement in private feeds to the owners of those feeds, private feed owners can understand how and when the subscribers to the user's private feed(s) engage with specific types of content. The feed owner user can use that understanding, for example, to inform third-party content providers of which types of content may be effective for the subscribers to the private feed, and in order to engage with their subscribers.

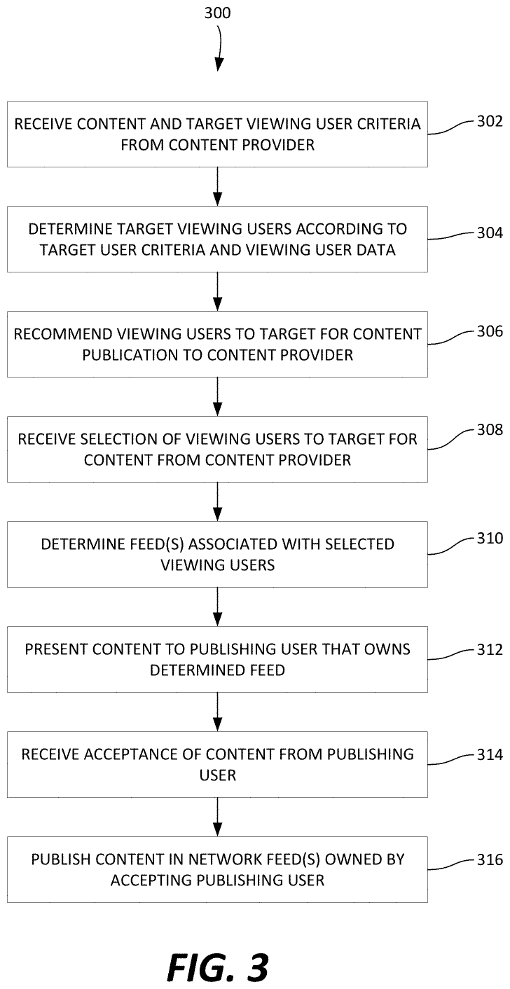

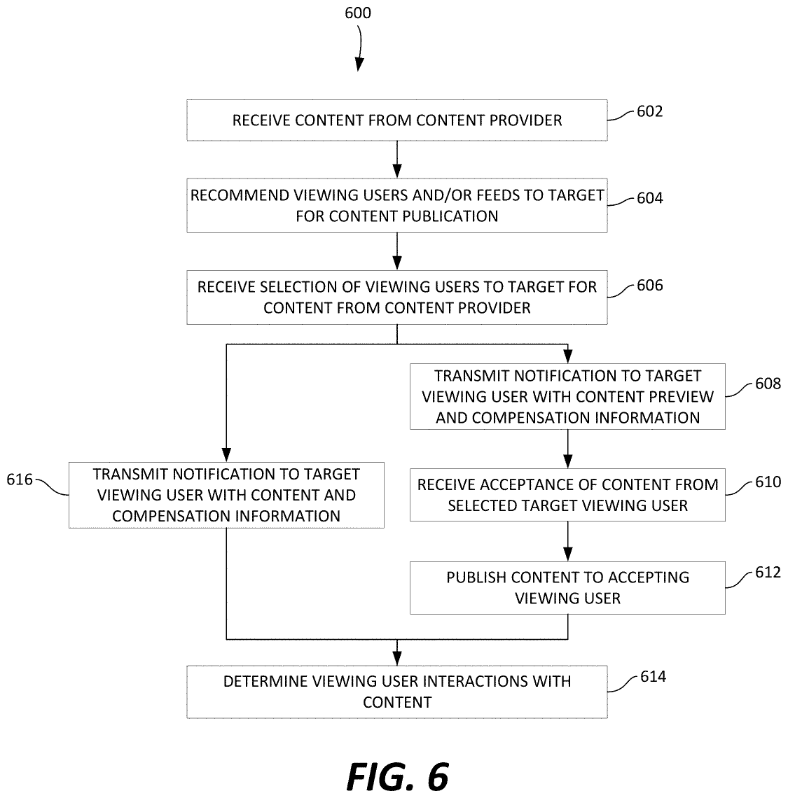

FIG. 3 is a flow chart illustrating an example method 300 for presenting third-party content to one or more users of an electronic network, such as a streaming network or social network. The method 300 of FIG. 3, or one or more aspects thereof, may be performed by the third-party content management system 114 of FIG. 1. The method 300 of FIG. 3 may represent a novel approach to third-party content publication on an electronic network. As will be described in further detail below, the method 300 may include analyzing viewing user 116 data to determine the best publishing user 118 feeds in which to publish content, offering the content to the publishing user 118 owners of such feeds, and publishing the content in publishing user's feed only if the publishing user 118 affirmatively accepts the content. Accordingly, the method FIG. 3 addresses embodiments in which publishing users 118 determine which content publishes to viewing users 116 of their feeds. With respect to FIG. 6, a method 600 will later be described which addresses embodiments in which viewing users 116 determine which content publishes to them.

The method 300 will be described with reference to receiving information from, and presenting information to, third-party content providers and publishing users 118. Such information exchange may be performed through a third-party content provider portal 126 and a publishing user portal 128, as described herein.

The method 300 may include, at block 302, receiving content and target viewing user criteria from a third-party content provider. The content and criteria may be received electronically from the third-party content provider 110, in an embodiment, such as through a dedicated content upload feature hosted by the third-party content management system 104 and accessible to the third-party content provider 110. The content may include one or more of text, images, video, and/or other media. The content may be an advertisement, news article, etc.

The received target viewing user criteria may include one or more parameters of desired target viewing users 116 for the content, in an embodiment. For example, such parameters may include one or more interests (e.g., activities, hobbies, topics, etc.) of a target viewing user 116, demographic characteristics of a target viewing user 116 (e.g., age, gender, marital status, location, education level, etc.), and/or actions associated with a target viewing user 116 (e.g., types of purchases or particular purchases, amount of time spent on the network, etc.). Accordingly, the targeting criteria for content may include a plurality of user characteristics.

Receiving the content at block 302 may further include receiving a compensation associated with the content, i.e., a compensation to be offered to a publishing user who accepts the content to be published in the publishing user's feed, as will be described below. That is, receiving compensation at block 302 may include receiving an indication of compensation to be paid to a publishing user, rather than an exchange of compensation, in some embodiments. As will be described with respect to FIG. 6, that compensation may be shared with viewing users, in certain embodiments. Other information respective of the content may also be received, such as a desired publication schedule, for example.

In an embodiment, receiving content from a third-party content provider at block 302 may include receiving content direction from a third-party content provider. Receiving content direction from a third-party content provider may be substantially the same as receiving content from a third party as described above with respect to block 302, except a description of desired content may be received, instead of the content itself. Such a description can include, for example, an image template or text template to be modified by a user, a description of a desired photograph, or other directions to enable a user to create original content. As will be described below, the content description can then be utilized by a publishing user 118 to create original content as directed by the third party content provider.

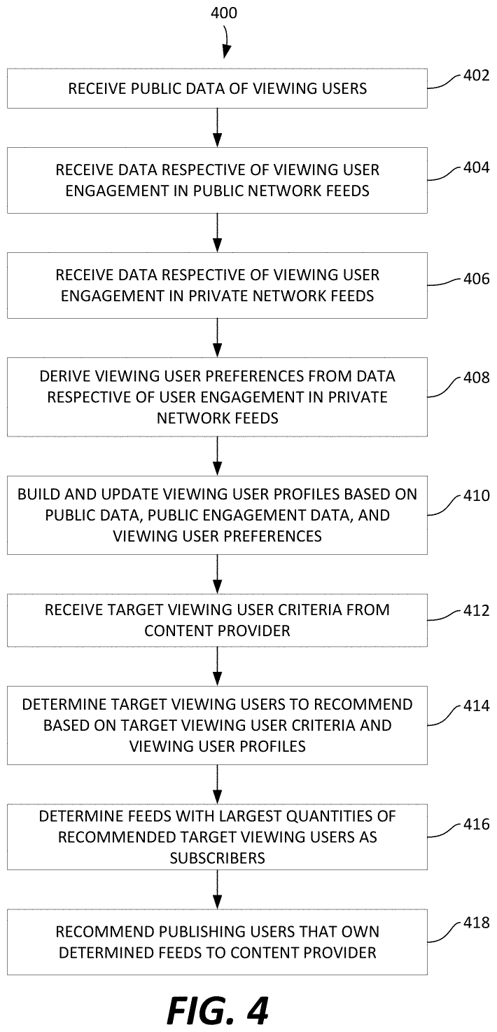

The method may include, at block 304, determining target viewing users 116 according to the target viewing user criteria and according to viewing user data. An example method for determining viewing users to target will be described with respect to FIG. 4. In general, determining viewing users to target may include comparing user characteristics (e.g., stored in the user data source 106 of FIG. 1) to targeting criteria received at block 302.

The method 300 may further include, at block 306, recommending viewing users to target for the content publication. The recommended users may be determined based on the viewer targeting criteria and based on data respective of end users of the network, in an embodiment. Recommending viewing users at block 306 may include transmitting a list of viewing users to the content provider from which the content and criteria were received in block 302.

The method 300 may further include, at block 308, receiving a selection, from the third-party content provider, of viewing users to target for the content. The received selection may be a selection of one or more of the viewing users recommended at block 306, in an embodiment. Accordingly, the received selection may include one or more specific viewing users to which the third-party content provider would like the content shown.

The method 300 may further include, at block 310, determining one or more feeds associated with the selected viewing users. Determining one or more feeds at block 310 may include determining feeds that include the largest number of selected target viewing users, in some embodiments. Additionally or alternatively, determining one or more feeds at block 310 may include determining feeds that have viewing users that most closely match the target criteria. Additionally or alternatively, determining one or more feeds at block 310 may include a weighted combination of number of selected target viewing users and the closeness of match of those selected target viewing users to the target criteria.

In some embodiments, determining feeds at block 310 may be performed before recommended target viewing users are presented to the content provider at block 306, and recommending target viewing users at block 306 may include recommending specific feeds to the content provider. Further, receiving content provider selections of target viewing users at block 308 may include receiving selections of one or more feeds from the content provider.

Although blocks 306, 308, 310 may result in numerous feeds being determined and/or selected, and those feeds may be respectively associated with numerous publishing users, the remainder of the method 300 will be described with respect to a single publishing user and a single feed for ease of description.

The method 300 may further include, at block 312, presenting the content to the publishing user that owns the feed selected by the third-party content provider or otherwise determined at block 310. Presenting the content may include presenting the content in its entirety, or a portion of the content, to the publishing user, along with the compensation associated with the content, a desired content publication schedule, the identity and/or other information about the third-party content provider, and/or other information associated with the content to enable the publishing user to determine whether or not to accept the content for publication in the publishing user's feed.

Presenting the content to the publishing user at block 312 may include, in an embodiment, facilitating communication between the third-party content provider and the publishing user, such as by direct message on the network, email, etc., to enable the third-party content provider and the publishing user to discuss the content, the compensation for the content, the publication schedule, etc.

In an embodiment, instead of presenting the content to the publishing user selected by the third-party content provider, the method 300 may include presenting a content description to the publishing user selected by the third-party content provider. Presenting a content description may be substantially the same as presenting content as described above with respect to block 312, except a description of desired content may be presented, instead of the content itself. Such a description can include, for example, an image template or text template to be modified by a user, a description of a desired photograph, or other directions to enable a user to create original content. As will be described below, the content description can then be utilized by a user to create original content as directed by the third party.

The method 300 may further include, at block 314, receiving an acceptance of the content from the publishing user selected by the third-party content provider. A publishing user may receive numerous requests from third-party content providers (e.g., through the process of the method 300) to publish content in one or more of the publishing user's feeds. At block 314, the publishing user may select or reject one or more items of content for publication in the publishing user's feed, based on the content, the compensation associated with the content, etc. Receiving publishing user acceptance may include, in an embodiment, receiving input from the publishing user regarding the publication schedule of the content.

The publishing user may reject content that is presented to the publishing user. In response to receiving a publishing user rejection of the content, the third-party content management system will not publish the content in the feed of the rejecting publishing user.

The method 300 may further include, at block 316, publishing the content in the network feed owned by the accepting publishing user. In an embodiment, the content may be published according to a publication schedule received from the content provider or from the publishing user.

In an embodiment in which the third party content provider provides a content description instead of the content itself, publishing the content at block 316 may include receiving content generated by the publishing user that is based on the content description and publishing that publishing user-generated content.

The operations of blocks 312, 314, 316 may be repeated (e.g., performed separately and in parallel, or serially) to publish, or attempt to publish, the content in numerous feeds owned by numerous respective publishing users.

Publishing third-party content on a network according to the method 300 offers numerous advantages over known methods and systems. First, unlike many known network publication methods, publication according to the method 300 allows publishing users to control which third-party content appears in the feeds they own, but without requiring independent discovery of that third-party content by the publishing user, resulting in an improved user experience and improved engagement. Second, target viewing user criteria may be matched to viewing users, such that viewing user targeting is based on activities and characteristics of specific viewing users, not more broadly based on groups to which those viewing users belong, resulting in improved content matching between content and viewing user.

FIG. 4 is a flow chart illustrating an example method 400 of determining viewing users as target viewing users, determining feeds as target feeds, and recommending selected viewing users and/or feeds for publication of third-party content. The method 400 of FIG. 4, or aspects thereof, may find use at blocks 304, 306, 310 in the method 300 of FIG. 3, in an embodiment. The method 400 of FIG. 4, or one or more aspects thereof, may be performed by the third-party content management system 104 of FIG. 1.

The method 400 may find user with embodiments in which the relevant network is a social network and content publication is associated with feeds associated with particular publishing users. Aspects of the method 400 may also find use with embodiments in which the relevant network is a social, streaming, or other network and content publication is direct from third party content providers to viewing users. After the method 400 is described, modifications to the method 400 will be described for application to embodiments of such a context.

The method 400 will be described with reference to multiple viewing users. It should be understood that aspects of the method 400 may be applied to a plurality of viewing users (e.g., some or all of the viewing users of a social network) to determine respective profiles of each of those viewing users and to determine whether (and/or to what degree) each of those viewing users, independently, is an appropriate or desirable target viewer for given third-party content.

The method 400 may include, at block 402, receiving public data of viewing users. The public data may be profile data entered by the viewing users on the network, such as name, age, location, etc. The public data may further include data respective of other online activity of the viewing user, including data received directly from the viewing user and data not received directly from the viewing user, such as search engine entries, online commerce activity (e.g., products viewed, products purchased, etc.), platforms on which the viewing user has accounts (e.g., other social media networks, email platforms, etc.), and other publicly-available data respective of the viewing user (e.g., other data that is not predicated on the viewing user's activity on the network).

The method 400 may further include, at block 404, receiving public engagement data respective of the viewing users. The public engagement data may be representative of a viewing user's activity in public feeds on the network, such as comments, likes, and other responses to content, the amount of time (e.g., average time, total time, etc.) the viewing user has spent viewing particular types of content or particular items of content, the amount of time the viewing user spends viewing the network or a particular feed of the network, the feeds to which the viewing user is subscribed or regularly views, etc.

The method 400 may further include, at block 406, receiving data respective of viewing user engagement in private network feeds and, at block 408, deriving viewing user preferences from the data respective of viewing user engagement in the private network feeds. The viewing user preferences may be extrapolated from the private feed viewing user engagement data, in an embodiment. For example, if a viewing user comments positively on, likes, or otherwise positively engages with an item of content in a private feed—for example, content related to a particular brand of automobile—it may be extrapolated that the viewing user has a preference for or interest in automobiles generally, and/or for the type or brand of automobile that is the subject of the engaged content. The viewing user data itself, however—the specific viewing user interaction with the content in the private feed—may not be available for use by the third-party content management system. Instead, as described herein, such data may be encrypted, for decryption only based on a decryption key provided to the publishing user owner of the feed in which the interaction took place. In this way, the viewing user's privacy as to engagement in private feeds may be protected, while also extrapolating an understanding of the viewing user's interests based on that activity to better match the viewing user to content.

The method 400 may further include, at block 410, building and updating viewing user profiles based on the public data, the public engagement data, and the viewing user preferences. A viewing user profile may be built for each viewing user of the network, in an embodiment, and updated as new data respective of the viewing user is received (e.g., as the viewing user further interacts on the network or produces further non-network data). Each viewing user's profile may be based on the public data, public engagement data, and user preferences respective of that viewing user. The viewing user profiles may be stored in the user data source 106 of FIG. 1, in an embodiment.

The method 400 may further include, at block 412, receiving target viewing user criteria respective of content from a third-party content provider. As described herein, the target viewing user criteria may include demographics, interests, and/or other characteristics of viewing users that the third-party content provider would like to target as viewers for particular content.

The method 400 may further include, at block 414, selecting viewing user targets to recommend based on the target criteria and the viewing user profiles. Selecting viewing user targets may include for example, comparing targeting criteria received at block 412 with viewing user profiles built and updated according to block 410. For example, the targeting criteria may be compared to viewing user profiles on a characteristic-by-characteristic basis to determine how many of the characteristics in the targeting criteria are present in each viewing user profile. The more targeting characteristics that are present in a given viewing user profile, the higher percentage match that viewing user may be to the targeting criteria, in an embodiment. Targeting characteristics may be weighted relative to other characteristics, in embodiments.

The method 400 may further include, at block 416, determining one or more feeds with the largest quantities of recommended target viewing users as subscribers. For example, in an embodiment, the quantity of viewing users that match the targeting criteria above a user-by-user threshold may be determined for each of a plurality of feeds (e.g., for each feed in the network). In another embodiment, each feed may be given a match score, based on a weighted number of viewing users that match the targeting criteria (e.g., where viewing users that have a higher degree of match to the targeting criteria are given higher weight).

The method 400 may further include, at block 418, recommending the one or more feeds with the largest quantities of recommended viewing user targets, and specifically the publishing user owners of those feeds, to the third-party content provider. The recommendation may be made in a third-party content provider portal, as described herein. Further, as described herein, the content can be offered to the publishing user owners of those feeds for publication in their feeds.

As noted above, portions of the method 400 may be applied to embodiments in which the third party content provider selects individual viewing users so that the content provider can offer the content to the viewing users directly, rather than to publishing users. Such embodiments may be implemented in a social network, streaming network, or other network. In such embodiments, the operations of blocks 402, 404, 406, 408, 410, 412, 414 may be performed. In addition, the target viewing users determined at block 414 may be recommended to the content provider.

In still other embodiments, portions of the method 400 may be applied for a third party content provider to select feeds in a network that are not associated with particular publishing users (e.g., embodiments in which the network provider owns the particular feed). In such embodiments, the operations of blocks 402, 404, 406, 408, 410, 412, 414, 416 may be performed. In addition, the feeds determined at block 416 may be recommended to the content provider.

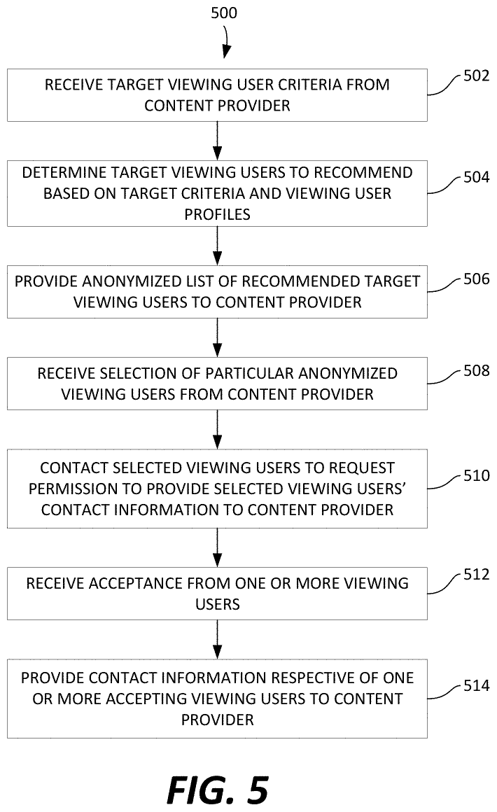

FIG. 5 is a flow chart illustrating an example method 500 of selecting users as target viewers for third-party content. The method 500 of FIG. 5, or one or more aspects thereof, may be performed by the third-party content management system 104 of FIG. 1. The method 500 may be applied in conjunction with a social network, streaming network, or other electronic network to provide target viewing user recommendations to third party content providers and facilitate communications between the content providers and target viewing users.

The method 500 may include, at block 502, receiving target viewing user criteria from a third party content provider. Block 502 may be substantially the same as block 412 of the method 400 of FIG. 4, in embodiments.

The method 500 may further include, at block 504, determining target viewing users to recommend based on the target viewing user criteria received at block 502. Block 504 may be substantially the same as block 414 of the method 400 of FIG. 4, in embodiments.

The method 500 may further include, at block 506, providing an anonymized list of recommended target viewing users to the third party content provider. The anonymized list may include the target viewing users determined at block 504, in embodiments. The anonymized list may include a number or other anonymous identifier respective of each individual viewing user on the list. The anonymized list may be provided to the third party content provider automatically in response to receiving target viewing user criteria and determining target viewing users, in an embodiment.

The method 500 may further include, at block 508, receiving a selection of particular anonymized viewing users, selected from the list provided at block 506, from the third party content provider. The selection may include all of the anonymized viewing users in the list provided at block 506, or may include a subset of the anonymized viewing users.

The method 500 may further include, at block 510, contacting the selected viewing users to request permission to provide the viewing users' contact information to the third party content provider in response to receiving the selection at block 508. The selected viewing users may be contacted through messaging feature or other communication means of the network of which they are viewing users, for example. In some embodiments, the selected viewing users may be contacted through an e-mail, text message, or other form of electronic communication that is external to or outside of the electronic network on which they are viewing users. Contacting the selected viewing users may be performed automatically in response to receiving the selection of particular anonymized viewing users at block 508.

Contacting the selected viewing users at block 510 may include providing information to the viewing users about the third-party content that the third-party content provider wishes to publish to the users. For example, the information may include a type of content (e.g., advertisement, news article, etc.), a compensation to the viewing user for receiving the content, a subject matter of the content, the identity of the third party content provider, etc. The compensation may be, for example, government-issued currency or equivalent credit, in some embodiments. In other embodiments, the compensation may be, for example, a gift card or other credit associated with the third party content provider and/or with the electronic network. Based on the information, each viewing user may decide whether or not the viewing user would like to receive the content in exchange for the proposed compensation.

The method 500 may further include, at block 512, receiving an acceptance from one or more of the contacted viewing users. The acceptance(s) may be received through the same communication channel as the contacting performed in block 510, in embodiments. Alternatively, the acceptance may be received through a separate communication channel. For example, in an embodiment, a user may be contacted through an email to request that user's permission at block 510, and the user may indicate acceptance through a menu of the electronic network (and the acceptance may thus be received through the network) at block 512.

The method 500 may further include, at block 514, providing the contact information of the one or more accepting viewing users to the third party content provider. The contact information may include, for example, a user name on the network, a phone number, an email address, etc. Upon receiving the user contact information, the third party content provider may contact the users to publish the content to the users.

The method 500 may advantageously enable third party content providers to find viewing users that meet content targeting criteria, without exposing the contact or other personal information of those viewing users to the third party content provider without the viewing user's consent. Furthermore, because the method 500 provides for case-by-case consent by the viewing user for each item of content, the viewing user is not required to broadly or categorically consent (or not consent) to third-party content or certain types of third party content.

FIG. 6 is a flow chart illustrating an example method 600 for presenting third-party content, such as an advertisement, to one or more network users, such as one or more users of a social network or a media streaming network. The method 600 of FIG. 6, or one or more aspects thereof, may be performed by the third-party content management system 104 of FIG. 1. The method 600 of FIG. 6 may represent a novel approach to third-party content publication on an electronic content network. As will be described in further detail below, the method 600 may include analyzing viewing user data to determine the best viewing users to whom to target content, transmitting a notification to target viewing users, transmitting the content to the target viewing users only if the target viewing users explicitly accept the content, and compensating viewing users that perform predefined behaviors with respect to the content. The method 600 will be described with respect to embodiments in which the third-party content is an advertisement, but it should be understood that other types of third-party content that may desirably be shown to users on a social network or content streaming network may find use with the method 600.

The method 600 may include, at block 602, receiving content and target viewing user criteria from a third-party content provider. Block 602 may be substantially similar to block 302 of the method 300 of FIG. 3.

Block 602 may further include receiving an indication of compensation associated with the content, i.e., a compensation to be offered to a viewing user who accepts the content for viewing and performs a predefined action with respect to the content, as will be described below. The compensation may be provided by the owner of the content along with which the advertising content is intended to be shown. The advertiser or owner of the advertising content may have compensated the owner of the streaming or social media content for causing the advertising content to be shown in association with the streaming or social media content. Accordingly, the compensation provided by the advertiser or owner of the advertising content may be split between the owner of the streaming or social media content and viewers of the advertising content. For example, in a social media network context, the third-party content provider may compensate a publishing user 118, and the publishing user 118 may share that compensation with their viewing users through aspects of the method 600.

In an embodiment in which the received content is an advertisement, the content may be received from the advertised party (e.g., the party that sells, makes or provides the advertised goods or services). In other embodiments in which the received content is an advertisement, the content may be received from a creator or provider of entertainment or news content in which the advertisement will be provided. In such an embodiment, the compensation for the advertisement from the advertiser to the owner of the entertainment content may be split by the entertainment content owner and the targeted users.

As noted above, aspects of the method 600 may enable a publishing user 118 or a network provider to split advertising compensation or other compensation associated with third-party content with viewing users. Nonetheless, the remainder of the method 600 will be described with respect to an embodiment in which compensation is provided from third-party content providers to viewing users, for ease of description.

The method 600 may further include, at block 604, recommending users to target to receive the advertisement. The recommended users may be determined based on the viewing user targeting criteria and based on data respective of the viewing users of the media streaming or social network, in an embodiment. An example method 400 for determining users to target based on user data and targeting criteria is described above with respect to FIG. 4.

The method 600 may further include, at block 606, receiving a selection of recommended viewing users to target for the content from the third-party content provider. The received selection may be a selection of one or more of the viewing users recommended at block 604, in an embodiment. Accordingly, the received selection may include one or more specific viewing users to which the third-party content provider would like the content shown.

In embodiments in which aspects of the method 600 are applied to enable a publishing user 118 to share compensation with viewing users that subscribe to or otherwise view a feed owned by the publishing user 118, the operations of block 604 may be omitted, and the publishing user may select one or more viewing users from their feed without a recommendation.

Although numerous viewing users may be recommended to and selected by the third-party content provider, the remainder of the method 600 will be described with respect to a single user, for ease of description.

The method 600 may further include, at block 608, transmitting a notification to the targeted viewing user. The notification may be transmitted to the viewing user as part of the media streaming or social network, in some embodiments. For example, where the viewing user has been targeted for an advertisement, and the advertisement is intended to be displayed during an intermission in a media stream (e.g., a break in a video stream, a time period between two songs in an audio stream, etc.), the notification may be transmitted to the user at the beginning of the media stream intermission. In another example, where the advertisement is to be provided to the user in a social network, the notification may be provided to the viewing user at the beginning of a post containing the advertisement.

Additionally or alternatively, the notification may be transmitted to the viewing user through a channel outside of the network. For example, the notification may be transmitted to the user through a text message or email. In some embodiments, numerous notifications (e.g., notifications respective of numerous advertisements) may be transmitted to a user in a single message. In other embodiments, a discrete respective message may be transmitted for each advertisement.

The notification may include a preview of the advertisement, an indication of compensation, and a prompt for a response from the viewing user, in some embodiments. The preview of the advertisement may include, for example, a screen capture of the advertisement, a clip portion of the advertisement (e.g., 3 seconds of a 30-second advertisement), and/or a textual description of the advertisement. The preview of the advertisement may include an indication of the product(s) or service(s) being advertised, the seller of the product(s) or service(s) (i.e., the third party providing the advertisement), and/or the duration of the advertisement, in some embodiments.

The indication of compensation included in the notification may include a set of compensation options, in some embodiments. For example, the notification may include a plurality of forms of compensation (e.g., a cash amount, a coupon, a product, etc.) form which the viewing user may select their preferred form of compensation for viewing the content. Additionally or alternatively, the indication of compensation included in the notification may include an open entry in which the viewing user may enter an amount of compensation that the user would accept to view the content. If the amount entered by the user is less than a predetermined threshold, the amount entered may be deemed to be an acceptance of the content by the user. If the amount entered by the viewing user is greater than the predetermined threshold, the amount entered may be deemed to be a rejection of the content by the user.

The prompt for a response from the viewing user may include one or more predetermined viewing user actions that must be performed by the viewing user in order to receive the compensation. Such viewing user actions may include, for example, viewing the third party content, taking a survey or otherwise answering one or more questions about the content, “sharing” the content in one or more of the viewing user's social media feed or via text message or other direct message, following a hyperlink associated with the content, interacting with a media post of the content such as by commenting or “liking”, etc.

The method 600 may further include, at block 610, receiving an acceptance of the content from the user. The user acceptance may be in response to the notification transmitted at block 608. The user acceptance may be received in a text message or email from the user, in some embodiments. Additionally or alternatively, the user acceptance may be received through a user click or other selection through the social network or media streaming network.

The user may reject the content, in some embodiments. In response, the advertisement will not be shown to the viewing user (in embodiments in which the notification includes a preview of the content). Further in response to receiving the user rejection, a separate notification may be presented to the viewing user, in some embodiments, with a separate advertisement or other item of content.

The method 600 may further include, at block 612, publishing the content (e.g., transmitting and displaying the content) to the viewing user in response to receiving the viewing user's acceptance of the content. In an embodiment, publishing the content to the viewing user may include displaying the content in an existing window or other interface portion in the social or content delivery network used by the viewing user. In other embodiments, publishing the content to the viewing user may include displaying the content is a new window or other interface portion.

The method 600 may further include, at block 614, determining viewing user interactions with the content. Determining viewing user interactions may include, for example, determining if a progress of the content (e.g., where the content includes a video or audio) reached a particular portion or timestamp when viewed by the viewing user, receiving a viewing user response to one or more questions associated with the content, receiving an indication that a viewing user loaded a file associated with the content, receiving an indication that a viewing user clicked through a hyperlink associated with the content, etc. In some embodiments, determining viewing user interactions at block 612 may include determining if the viewing user has performed the predetermined user response prompted in the notification of block 608.

In some embodiments, the notification transmitted to the user may include the entirety of the third party content instead of a preview of the content. Accordingly, in some embodiments, instead of blocks 608, 610, 612, the method may include, at block 616, transmitting a notification to the viewing user, the notification including the content and compensation information. The method 600 may then include determining viewing user interactions at block 612.

In embodiments, if it is determined at block 614 that the viewing user has performed the predetermined user response associated with compensation, then compensation may be remitted to the viewing user. In other embodiments, the compensation may be provided to the viewing user along with the content being transmitted at block 612. The compensation may be cash value, a coupon, a product, a currency associated with the social network or content streaming network, or other item of value to the user.

In some embodiments, steps 608, 610, 612, and 614, or 616 and 614, may occur during a single use session of the viewing user. For example, the user may be viewing entertainment content on a content streaming network and, during the content stream, a notification may be transmitted to the user (block 608), the user may respond to the notification and accept the content (block 610), the third-party content (e.g., advertisement) may be displayed to the user (block 612), and viewing user interactions with the content may be determined (block 614) all during the streaming session. In some embodiments, blocks 608, 610, and 612 may occur without interrupting the content stream, such as by transmitting and displaying the notification and receiving the user response in a separate window from the social network or streaming window used by the user, or by transmitting the notification in a text message or other separate communication channel. In other embodiments, steps 608, 610, and 612 may occur during an active user session, and the streaming or other network may interrupt the session while the operations of blocks 608, 610, 612, or 616, are performed. In still other embodiments, steps 608 and 610 may occur at a time other than during an active use session, and step 612 may occur during an active streaming or social network access session by the user.

In some embodiments, the method 600 may be applied to interact with the viewing user on the same electronic device as the viewing user is interacting with the social network, streaming network, or network with which the method 600 is associated. For example, where the viewing user is logged in to the network on a mobile computing device, blocks 608, 610, 612, and 614, or 616 and 614, may be performed via communications with that mobile computing device. In other embodiments, the method 600 may be applied to interact with the viewing user on a different electronic device (e.g., “second screen”) than the one the viewing user is interacting with the social network, streaming network, or network with which the method 600 is associated. For example, where the viewing user is logged in to the network on a television or desktop computer, blocks 608, 610, 612, and 614, or 616 and 614, may be performed via communications with a mobile computing device of the viewing user.

Displaying third-party content, such as advertisements or news, to users on a social network or a content streaming network according to the method 600 offers numerous advantages over known methods and systems. First, unlike many known advertisement delivery methods, content delivery according to the method 600 allows users to explicitly opt in to or opt out of specific advertisements, resulting in an improved user experience and improved engagement. Second, target viewer criteria may be matched to users, such that viewer targeting is based on activities and characteristics of specific users, not more broadly based on groups to which users belong, resulting in improved content matching between content and viewer user. Third, the compensation provided by the advertiser or owner of the advertising content may be split between the owner of the streaming or social media content and viewers of the advertising content, advantageously motivating both the owner of the streaming or social media content and users of the social media or content streaming network to cause the advertising content to be viewed.

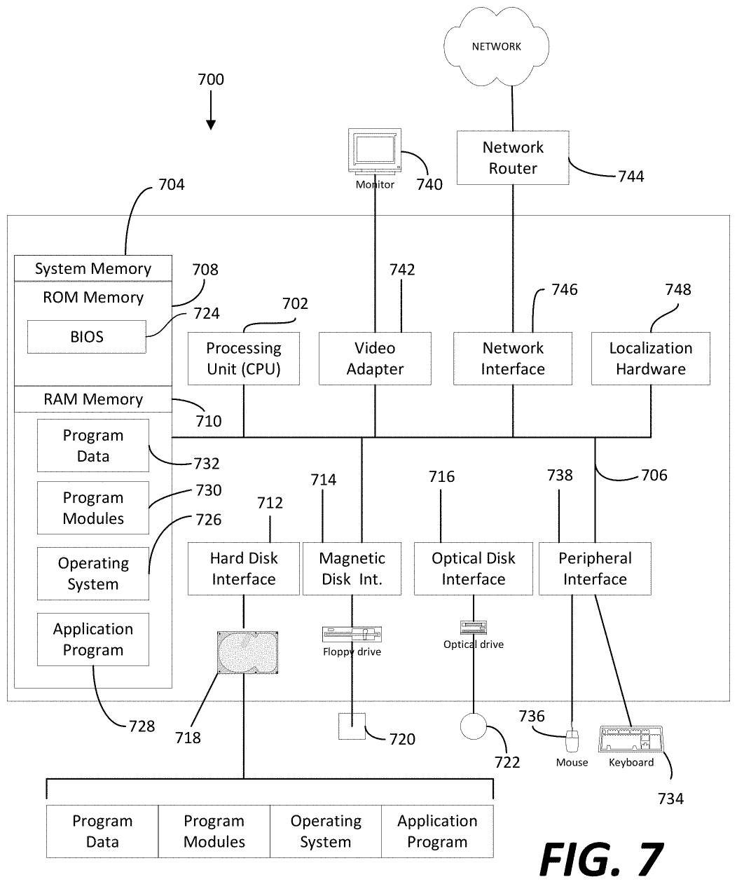

FIG. 7 is a diagrammatic view of an example embodiment of a user computing environment that includes a general purpose computing system environment 700, such as a desktop computer, laptop, smartphone, tablet, or any other such device having the ability to execute instructions, such as those stored within a non-transient, computer-readable medium. Furthermore, while described and illustrated in the context of a single computing system 700, those skilled in the art will also appreciate that the various tasks described hereinafter may be practiced in a distributed environment having multiple computing systems 700 linked via a local or wide-area network in which the executable instructions may be associated with and/or executed by one or more of multiple computing systems 700.

In its most basic configuration, computing system environment 700 typically includes at least one processing unit 702 and at least one memory 704, which may be linked via a bus 706. Depending on the exact configuration and type of computing system environment, memory 704 may be volatile (such as RAM 710), non-volatile (such as ROM 708, flash memory, etc.) or some combination of the two. Computing system environment 700 may have additional features and/or functionality. For example, computing system environment 700 may also include additional storage (removable and/or non-removable) including, but not limited to, magnetic or optical disks, tape drives and/or flash drives. Such additional memory devices may be made accessible to the computing system environment 700 by means of, for example, a hard disk drive interface 712, a magnetic disk drive interface 714, and/or an optical disk drive interface 716. As will be understood, these devices, which would be linked to the system bus 706, respectively, allow for reading from and writing to a hard disk 718, reading from or writing to a removable magnetic disk 720, and/or for reading from or writing to a removable optical disk 722, such as a CD/DVD ROM or other optical media. The drive interfaces and their associated computer-readable media allow for the nonvolatile storage of computer readable instructions, data structures, program modules and other data for the computing system environment 700. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 700.

A number of program modules may be stored in one or more of the memory/media devices. For example, a basic input/output system (BIOS) 724, containing the basic routines that help to transfer information between elements within the computing system environment 700, such as during start-up, may be stored in ROM 708. Similarly, RAM 710, hard drive 718, and/or peripheral memory devices may be used to store computer executable instructions comprising an operating system 726, one or more applications programs 728 (such as the modules 124, 126, 128, 130 of FIG. 1, or a browser or application for accessing a digital social media network), other program modules 730, and/or program data 732. Still further, computer-executable instructions may be downloaded to the computing environment 700 as needed, for example, via a network connection.

An end-user, e.g., an end user of a social network or a third-party content provider, may enter commands and information into the computing system environment 700 through input devices such as a keyboard 734 and/or a pointing device 736. While not illustrated, other input devices may include a microphone, a joystick, a game pad, a scanner, etc. These and other input devices would typically be connected to the processing unit 702 by means of a peripheral interface 738 which, in turn, would be coupled to bus 706. Input devices may be directly or indirectly connected to processor 702 via interfaces such as, for example, a parallel port, game port, firewire, or a universal serial bus (USB). To view information from the computing system environment 700, a monitor 740 or other type of display device may also be connected to bus 706 via an interface, such as via video adapter 742. In addition to the monitor 740, the computing system environment 700 may also include other peripheral output devices, not shown, such as speakers and printers.

The computing system environment 700 may also utilize logical connections to one or more computing system environments. Communications between the computing system environment 700 and the remote computing system environment may be exchanged via a further processing device, such a network router 744, that is responsible for network routing. Communications with the network router 744 may be performed via a network interface component 746. Thus, within such a networked environment, e.g., the Internet, World Wide Web, LAN, or other like type of wired or wireless network, it will be appreciated that program modules depicted relative to the computing system environment 700, or portions thereof, may be stored in the memory storage device(s) of the computing system environment 700.

The computing system environment 700 may also include localization hardware 748 for determining a location of the computing system environment 700. In embodiments, the localization hardware 748 may include, for example only, a GPS antenna, an RFID chip or reader, a WiFi antenna, or other computing hardware that may be used to capture or transmit signals that may be used to determine the location of the computing system environment 700.

The computing environment 700, or portions thereof, may comprise one or more components of the system 100 of FIG. 1, in embodiments, such as the social network provider 102, the third party content management system 104, the user data source 106, and/or the computing devices respective of the users 108 and the third party content providers 110.

In a first aspect of the present disclosure, an example server-implemented method of publishing content on an electronic content network is provided. The example method may include receiving, from a content provider: an item of content; a selection of a plurality of viewing users of the electronic content network; an indication of a compensation associated with the item of content; and an indication of a compensable viewing user action associated with the item of content. The example method may further include transmitting, to each of the selected viewing users, a respective notification comprising the indication of the compensation and the indication of the compensable viewing user action and determining that each of a first subset of the plurality of selected viewing users performed the compensable viewing user action in response to the notification and, in response, providing the compensation to each viewing user of the first subset. The example method may further include determining that each of a second subset of the plurality of selected viewing users did not perform the compensable viewing user action in response to the notification and, in response, withholding the compensation from each viewing user of the second subset.

In an embodiment of the first aspect, the notification comprises a preview of the item of content.

In an embodiment of the first aspect, the example method further includes receiving, in response to the notification, an acceptance of the item of content from each viewing user of a third subset of the plurality of the selected viewing users, the third subset comprising at least the first subset, and transmitting the item of content to each viewing user of the third subset in response to receiving the acceptance.

In an embodiment of the first aspect, the compensable viewing user action comprises viewing the item of content.

In an embodiment of the first aspect, the item of content is an item of secondary content, and the method further includes receiving, from the content provider, an indication of an item of primary content on the electronic network associated with the item of secondary content, and transmitting the notification to each of the selected users comprises transmitting the notification to each of the selected users when that selected user is viewing the item of primary content.

In an embodiment of the first aspect, the electronic content network is one or more of a streaming media network or a social network.

In an embodiment of the first aspect, the notification to each of the selected viewing users comprises transmitting the notification through the electronic content network.

In an embodiment of the first aspect, transmitting the notification to each of the selected viewing users comprises transmitting the notification through a channel outside of the electronic content network.

In an embodiment of the first aspect, the example method further includes providing a list of recommended viewing users to the content provider, and receiving, from the content provider in response to the list of recommended viewing users, the selection of the plurality of target viewing users of the electronic content, the selected plurality of target viewing users being a subset of the recommended viewing users.

In an embodiment of the first aspect, the method further includes receiving target viewing user criteria from the content provider, and comparing the target viewing user criteria with individual data respective of each a plurality of candidate viewing users of the electronic content network to determine recommended viewing users.

In a second aspect of the present disclosure, an example server-implemented method of publishing secondary content on an electronic content network which publishes primary content is provided. The example method includes receiving, from a content provider: an item of secondary content; a selection of primary content with which the secondary content is associated; a selection of a plurality of viewing users of the electronic content network; an indication of a compensation associated with the item of content; and an indication of a compensable viewing user action associated with the item of content. The example method may further include transmitting, to each of the selected viewing users, a respective notification comprising the indication of the compensation and the indication of the compensable viewing user action, each respective notification transmitted while the respective selected viewing user is viewing the selected primary content. The example method may further include determining that each of a first subset of the plurality of selected viewing users performed the compensable viewing user action in response to the notification and, in response, providing the compensation to each viewing user of the first subset, and determining that each of a second subset of the plurality of selected viewing users did not perform the compensable viewing user action in response to the notification and, in response, withholding the compensation from each viewing user of the second subset.

In an embodiment of the second aspect, the notification comprises a preview of the item of secondary content.

In an embodiment of the second aspect, the method further includes receiving, in response to the notification, an acceptance of the item of content from each viewing user of a third subset of the plurality of the selected viewing users, the third subset comprising at least the first subset, and transmitting the item of content to each viewing user of the third subset in response to receiving the acceptance.

In an embodiment of the second aspect, the compensable viewing user action comprises viewing the item of content.

In an embodiment of the second aspect, the item of secondary content is an advertisement.

In an embodiment of the second aspect, the electronic content network is one or more of a streaming media network or a social network.

In an embodiment of the second aspect, transmitting the notification to each of the selected viewing users comprises transmitting the notification through the electronic content network.

In an embodiment of the second aspect, transmitting the notification to each of the selected viewing users comprises transmitting the notification through a channel outside of the electronic content network.

In an embodiment of the second aspect, the example method further includes providing a list of recommended viewing users to the content provider, and receiving, from the content provider in response to the list of recommended viewing users, the selection of the plurality of target viewing users of the electronic content, the selected plurality of target viewing users being a subset of the recommended viewing users.

In an embodiment of the second aspect, the method further includes receiving target viewing user criteria from the content provider, and comparing the target viewing user criteria with individual data respective of each a plurality of candidate viewing users of the electronic content network to determine recommended viewing users.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure.

Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A server-implemented method of publishing content on an electronic content network, the method comprising:
receiving, from a content provider:
an item of content;
a selection of a plurality of viewing users of the electronic content network;
an indication of a compensation associated with the item of content;
an indication of a compensable viewing user action associated with the item of content;
transmitting, to each of the selected viewing users, a respective notification comprising the indication of the compensation and the indication of the compensable viewing user action;
determining that each of a first subset of the plurality of selected viewing users performed the compensable viewing user action in response to the notification and, in response, providing the compensation to each viewing user of the first subset; and
determining that each of a second subset of the plurality of selected viewing users did not perform the compensable viewing user action in response to the notification and, in response, withholding the compensation from each viewing user of the second subset.

2. The method of claim 1, wherein the notification comprises a preview of the item of content.

3. The method of claim 2, further comprising:
receiving, in response to the notification, an acceptance of the item of content from each viewing user of a third subset of the plurality of the selected viewing users, the third subset comprising at least the first subset; and
transmitting the item of content to each viewing user of the third subset in response to receiving the acceptance.

4. The method of claim 3, wherein the compensable viewing user action comprises viewing the item of content.

5. The method of claim 1, wherein:
the item of content is an item of secondary content;
the method further comprises receiving, from the content provider, an indication of an item of primary content on the electronic network associated with the item of secondary content; and
transmitting the notification to each of the selected users comprises transmitting the notification to each of the selected users when that selected user is viewing the item of primary content.

6. The method of claim 1, wherein the electronic content network is one or more of a streaming media network or a social network.

7. The method of claim 1, wherein transmitting the notification to each of the selected viewing users comprises transmitting the notification through the electronic content network.

8. The method of claim 1, wherein transmitting the notification to each of the selected viewing users comprises transmitting the notification through a channel outside of the electronic content network.

9. The method of claim 1, further comprising:
providing a list of recommended viewing users to the content provider; and
receiving, from the content provider in response to the list of recommended viewing users, the selection of the plurality of target viewing users of the electronic content, the selected plurality of target viewing users being a subset of the recommended viewing users.

10. The method of claim 9, further comprising:
receiving target viewing user criteria from the content provider;
comparing the target viewing user criteria with individual data respective of each a plurality of candidate viewing users of the electronic content network to determine recommended viewing users.

11. A server-implemented method of publishing secondary content on an electronic content network which publishes primary content, the method comprising:
receiving, from a content provider:
an item of secondary content;
a selection of primary content with which the secondary content is associated;
a selection of a plurality of viewing users of the electronic content network;
an indication of a compensation associated with the item of content;
an indication of a compensable viewing user action associated with the item of content;
transmitting, to each of the selected viewing users, a respective notification comprising the indication of the compensation and the indication of the compensable viewing user action, each respective notification transmitted while the respective selected viewing user is viewing the selected primary content;
determining that each of a first subset of the plurality of selected viewing users performed the compensable viewing user action in response to the notification and, in response, providing the compensation to each viewing user of the first subset; and
determining that each of a second subset of the plurality of selected viewing users did not perform the compensable viewing user action in response to the notification and, in response, withholding the compensation from each viewing user of the second subset.

12. The method of claim 11, wherein the notification comprises a preview of the item of secondary content.

13. The method of claim 12, further comprising:
receiving, in response to the notification, an acceptance of the item of secondary content from each viewing user of a third subset of the plurality of the selected viewing users, the third subset comprising at least the first subset; and
transmitting the item of secondary content to each viewing user of the third subset in response to receiving the acceptance.

14. The method of claim 13, wherein the compensable viewing user action comprises viewing the item of secondary content.

15. The method of claim 11, wherein the item of secondary content is an advertisement.

16. The method of claim 11, wherein the electronic content network is one or more of a streaming media network or a social network.

17. The method of claim 11, wherein transmitting the notification to each of the selected viewing users comprises transmitting the notification through the electronic content network.

18. The method of claim 11, wherein transmitting the notification to each of the selected viewing users comprises transmitting the notification through a channel outside of the electronic content network.

19. The method of claim 11, further comprising:
providing a list of recommended viewing users to the content provider; and
receiving, from the content provider in response to the list of recommended viewing users, the selection of the plurality of target viewing users of the electronic content, the selected plurality of target viewing users being a subset of the recommended viewing users.

20. The method of claim 19, further comprising:
receiving target viewing user criteria from the content provider;
comparing the target viewing user criteria with individual data respective of each a plurality of candidate viewing users of the electronic content network to determine recommended viewing users.
